(19) United States
(12) Patent Application Publication
(10) Pub. No.: US 2013/0039352 A1
(43) Pub. Date: Feb. 14, 2013

(54) CONFIGURING A WIRELESS NETWORK INTERFACE TO PROVIDE A NETWORK SERVICE

(71) Applicants: Jean-Pierre Ruster, Sunnyvale, CA (US); Chandra S. Buddhavaram, Fremont, CA (US)

(72) Inventors: Jean-Pierre Ruster, Sunnyvale, CA (US); Chandra S. Buddhavaram, Fremont, CA (US)

(73) Assignee: SEAGATE TECHNOLOGY LLC., Cupertino, CA (US)

(21) Appl. No.: 13/207,989

(22) Filed: Aug. 11, 2011

(51) Int. Cl. H04W 88/02

(52) U.S. Cl. 370/338; 370/328

(57) ABSTRACT

A wireless network interface of an apparatus is configured to operate in an infrastructure client mode if at least one predetermined wireless access point is detected via the wireless network interface. Otherwise, the wireless network interface is configured to operate in an infrastructure access point mode. A network service of the apparatus is provided via the configured wireless network interface.

### SUMMARY

The present disclosure is related to systems and methods for configuration a wireless network interface to provide a network service. For example, in one embodiment, a method, apparatus, and/or computer readable medium facilitate setting a wireless network interface of an apparatus to operate in an infrastructure client mode if at least one predetermined wireless access point is detected via the wireless network interface. Otherwise, the wireless network interface is configured to operate in an infrastructure access point mode. A network service of the apparatus is provided via the configured wireless network interface.

These and other features and aspects of various embodiments may be understood in view of the following detailed discussion and accompanying drawings.

### BRIEF DESCRIPTION OF THE DRAWINGS

In the following diagrams, the same reference numbers may be used to identify similar/same components in multiple figures.

FIGS. 1A and 1B are a block diagrams of device interactions in various network environments according to example embodiments;

FIG. 2 are user interface screens illustrating user configuration of a peripheral device according to an example embodiment;

FIGS. 3 and 4 are flowcharts of procedures according to example embodiments;

FIG. 5 is a block diagram of an apparatus according to an example embodiment; and

FIG. 6 is a flowchart illustrating a procedure according to an example embodiment.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the claims appended hereto.

The present disclosure is generally related to apparatuses, systems and methods that provide wireless communications between wireless networking devices, such as a mobile host device (e.g., smart phone, tablet computer, portable gaming device, navigation system, vehicle electronics, etc.) and mobile peripheral device (e.g., storage device, printer, input/output device, etc.). Generally, the peripheral device may be configured to provide a service to the host device via wireless networking. As described in greater detail below, the peripheral device may include features that facilitate connecting the host to the peripheral via a wireless network under different conditions and with minimal user intervention with the peripheral device.

Wireless networking protocols may include features (e.g., addressing, routing, contention management) that allow multiple computers to automatically join and interact with a local network. Protocols such as dynamic host configuration protocol (DHCP) allow automatic configuration of some network parameters (e.g., addresses, subnetworks, routes, services) thereby freeing end users from having to configure these parameters manually Such configuration services may be provided by a fixed/infrastructure component of the network, such as a server or router.

Wireless networking protocols, such as the IEEE 802.11 family of wireless local area networking (WLAN) protocols, may also utilize infrastructure devices as a central point in the networks. In such a case, devices joining the network are said to be operating in infrastructure mode. In infrastructure mode, wireless client devices join the WLAN via an infrastructure access point (AP). A wireless AP may provide functions such as advertising a network identifier (SSID), authentication, encryption, configuration via DHCP, and bridging/routing to other networks. Consumer devices (e.g., computer, mobile device) are often set up to run in infrastructure mode by default. In such a case, the device will search for SSIDs from nearby APs, allow the user to select an SSID to connect to, and facilitate the entry of passwords, which can be used to authenticate to the network as well as to encrypt the wireless traffic. Thereafter, the user's device can subsequently connect to the network automatically using this data. A reference to this connection may be stored in memory (or otherwise recorded) so that the user's device can automatically connect later to the wireless network when the SSID is detected.

Wireless networking can also be used for point-to-point communications. For example, the IEEE 802.11 standards define an ad-hoc mode of operation. In ad-hoc mode two computers can establish a communication path directly between their wireless network cards without requiring the use of an infrastructure device, such as a WLAN AP. To set up an ad-hoc wireless network, each wireless device is configured for ad-hoc mode versus infrastructure mode. All wireless adapters on the ad-hoc network use the same SSID and the same channel number. This allows for convenient inter-device communications. Due to their point-to-point nature, ad-hoc networks may not have built-in mechanisms for accessing larger scale networks (e.g., the Internet).

As noted above, consumer devices may be set up by default to work on infrastructure networks (e.g., to find and connect to a wireless AP). This allows for ready access to the Internet, which is often the primary target of interest to a user of the client device. Even so, infrastructure mode can still be used for point-to-point communications between two device where no Internet routing is provided. For example, a peripheral device (e.g., data storage device) may use a wireless interface configured to operate as an infrastructure AP. To connect to the peripheral device, the user utilizes the already familiar infrastructure network configuration interface of the device to connect to the peripheral. This also allows multiple devices to access the peripheral at the same time, as multiple clients can connect to a single AP.

One issue that may arise by using a peripheral as an AP is that this may prevent the user's device from connecting other networks, including the Internet, while connected to the peripheral. Unless the peripheral device also includes a bridge to some other network, client devices connected to the peripheral may only be able to communicate with the peripheral (and possibly to one another) via the wireless network established by the peripheral's AP. This may be acceptable in some cases, but may not be in others.

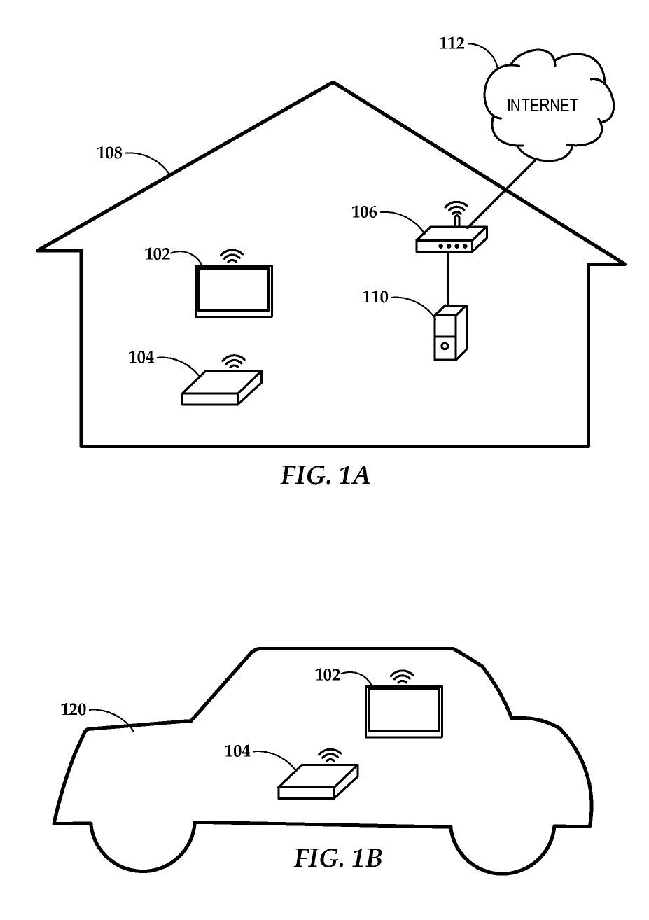

In reference to FIGS. 1A-1B, block diagrams illustrate scenarios for interaction with a peripheral according to example embodiments. In FIGS. 1A-1B, a user device 102 connects to a peripheral device 104 via wireless networking. For purposes of illustration, the user device 102 is shown as a tablet computer, and the peripheral device 104 is a portable storage device, such as a hard disk drive (HDD) or solid-state drive (SSD). In this example, the portable drive 104 is used to store a library of movies that can be streamed to the client device 102 for viewing. The scenario may be equally applicable to other types of peripheral devices 104 and associated services, such as printers, user input-output devices, sensors, etc.

In FIG. 1A, the devices 102, 104 are in an environment 108 where a known network AP 106 resides. The network AP 106 manages local connections to the WLAN, and provides a route to the Internet 112. The AP 106 may include a wireless gateway/router, wireless server, wireless cable modem, wireless mobile network device (e.g., used to access a 3G or 4G cellular network), or the like. The environment 108 may include any location (e.g., work, school, business) where the user of devices 102, 104 has sufficient trust in the network AP 106 to allow devices 102, 104 to automatically connect to the AP 106.

In order to use the portable drive 104 to stream movies in this environment, the drive 104 may also be configured as an AP, and the user device 102 can connect directly to the drive 104. However, this may preclude connecting the user device 102 to the AP 106 gateway/router. In some scenarios, the user may still desire connections to the Internet 112 and with other devices (e.g., home server 110) while streaming the movie. For example, the user may wish to still receive emails or text messages on device 102 while the movie is playing.

In such a case, the portable drive 104 may instead be configured as a wireless network client and automatically connect to the home network AP 106. In this way, the client device 102 can simultaneously connect to the portable drive 104, the Internet 112, and/or other device 110 on the home network. One difference between using the portable drive 104 as a wireless client and as a wireless AP is that the user device 102 may need additional information to locate the drive 104 when the drive 104 is a network client.

When the portable drive 104 acts as a wireless AP, it can configure the network parameters (including its own address) to some predetermined configuration, allowing any connecting device to know beforehand how to find the drive 104 after connecting to the drive's AP. In contrast, when the drive 104 connects as a client, it is the home network AP 106 that dictates at least some of the network parameters. In such a case, the client device 102 may use a discovery procedure to locate the drive 104 on the home network. As will be discussed in greater detail below, there are a number of ways for this device discovery to be implemented.

In FIG. 1B, the devices 102, 104 are in a location 120 (e.g., a car) where no other APs are available. In this case, the drive 104 is configured as an AP and the device 102 connects directly to the drive 104 as previously described. Because there is no WLAN Internet access in this environment, this does not sacrifice any connectivity as it might in the other environment 108. Further, because there is no AP in this environment, the client device 102 may not be able to connect to the drive 104, at least in infrastructure client mode, unless the drive 104 is configured as an AP. It is also possible that the drive 104 could operate in ad-hoc mode, which would also allow the device 102 to connect directly to the drive 104. Using ad-hoc mode, the portable drive 104 may also require service discovery, depending whether or not the drive 104 can set predetermined network parameters in ad-hoc mode.

It should be noted that the scenario described in relation to FIG. 1B may be equally applicable to situations where an AP is available, but the user does not wish to connect one or more of the devices 102, 104 to the AP. This may be the case where the AP is unsecured, untrusted, unnecessary, incurs usage fees, etc. In such a case, the portable drive 104 could still be set up as an infrastructure AP (or in ad-hoc mode) and the device 102 could connect directly to the drive 104 as described above.

In the scenarios described in FIGS. 1A and 1B, the portable drive 104 can be enabled to automatically detect different environments 108, 120 and set up a wireless network interface accordingly. For example, the portable drive 104 could be associated with the home network AP 106 by the user (or in other ways described below). The portable drive 104 can then operate its wireless network interface in an infrastructure client mode if this AP 106 is detected, otherwise the drive 104 will set the interface in infrastructure AP mode. The portable drive 104 can be set to detect any number of wireless APs in this way.

The portable drive 104 may also be preconfigured with data that references particular APs. For example, a service provider may offer free WLAN access at a number of locations. The drive 104 can be preconfigured during manufacturing or distribution with a listing of these WLAN access points, and other data needed to connect (e.g., encryption and authentication keys). This can also be performed by the user, e.g., by downloading and applying a listing to the drive 104 after establishing an account with the provider.

Another way to associate the portable drive 104 with an AP is to use an alternate data interface (e.g., USB port) that allows configuring the device 104 via a home computer to set WLAN parameters such as SSID, network key, etc. The device 104 may implement a technology such as Wi-Fi Protected Setup (WPA) that allows the device 104 to be automatically joined to a WLAN using options such as entering a personal identification number, pushing a button on the device and the AP at the same time, using near-field communications (NFC), using a USB stick, etc.

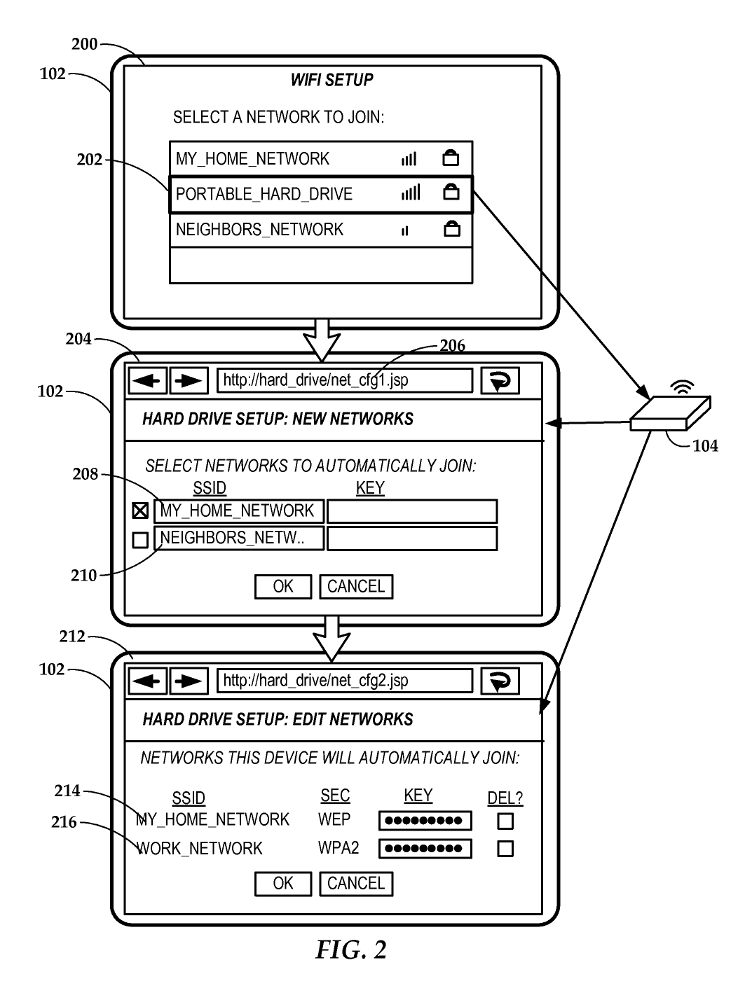

In FIG. 2, a series of user interface screens illustrates configuring of a wireless peripheral device 104 according to another example embodiment. This figure also describes the device 104 as a portable hard drive, although the concepts may be equally applicable to any type of peripheral device. In this example, a wireless AP can be provided from a wireless network interface of the peripheral device 104. The illustrated screenshots may be seen on a user device 102, such as a computer, mobile device, etc., although at least some of the data shown on the screen originates from the peripheral device 104, e.g., as a markup language document, and can be rendered using a standard browser. It will be appreciated that performing these operations on the user device 102 through the use of an integrated wireless AP and browser allows the configurations to be applied to a peripheral device 104 that has little or no user input/output hardware (e.g., buttons, displays, touchscreens). The configuration only requires access to the peripheral device 104 via the wireless network interface using a browser-equipped client 102.

Screen 200 in FIG. 2 represents a native wireless network configuration screen of the user device 102. Both the user device 102 and peripheral device 104 are powered on, and the peripheral device 104 is acting as an AP. This is detected by the user device 102, as shown in list entry 202. Infrastructure AP mode may be set as a default for the peripheral device 104 when no predetermined APs (e.g., trusted networks) are configured. In this screen, the user selects list entry 202 to connect. The user device 102 may perform additional operations needed to connect to the peripheral device AP, such as prompting the user for an encryption key/password. The peripheral device 104 may also be prevented (e.g., due to a security setting) from advertising its SSID (here shown as “PORTABLE_HARD_DRIVE”), in which case the user may be able to manually enter the SSID and other parameters.

After connection to the peripheral AP network, the user may configure the peripheral device 104 over the wireless connection. The user device 102 may be provisioned with a special-purpose application to configure the peripheral 104. Or, as shown in screen 204, a general-purpose browser may be used to configure the peripheral 104. The browser may be pointed to a particular Uniform Resource Locator (URL) 206 associated with the peripheral device 104. The URL may include an IP address or a hostname. In the latter case, the peripheral device 104 may also provide a name lookup service (e.g., domain name service) so that the user device 102 can resolve this hostname to an IP address.

In the page shown in screen 204, the user may be able to add infrastructure networks 208, 210 to which the peripheral device can automatically join as a client if the networks 208, 210 are detected. These may be auto-detected through advertisement of respective SSIDs, or manually entered where SSID is not advertised. In this example, network 208 is the user's home network to which the user desires to connect, and network 210 represents a neighbor's network to which the user does not desire to connect. Accordingly, the user has selected network 208, but not network 210. The screen 208 also allows inputting other data related to the networks 208, 210, such as network encryption keys.

After the user completes configuration of the peripheral 104 via screen 204, the identity of the selected network 208 may be kept in the peripheral device 104 (e.g., stored in persistent storage) for future reference, along with any other data needed to connect to the selected network 208. At this point, the user may choose to cause the peripheral device 104 to immediately reconfigure to client mode. In such a case the AP 202 shown in screen 200 would disappear, and the peripheral device 104 would connect to the home network 208 as a client. The user device 102 could subsequently access the peripheral device 104 via the home network 208, including accessing screens 204, 212 by way of a browser.

In screen 212, an example browser document provided by the peripheral device 104 shows how the user can edit networks stored with the peripheral device 104. The user can delete associated existing networks 214, 216 by way of right-hand column selection box. This screen 212 may also facilitate changing other data related to the networks, including encryption keys and type of encryption used. The deletion of a network 214, 216 may cause an immediate wireless mode change in the peripheral device 104. For example, if screen 212 is currently being accessed by way of home network 214, and work network 216 is not currently detected, then deletion of network 214 via screen 212 may cause the peripheral device 104 to go to infrastructure AP mode, where it can be directly accessed as seen in screen 200.

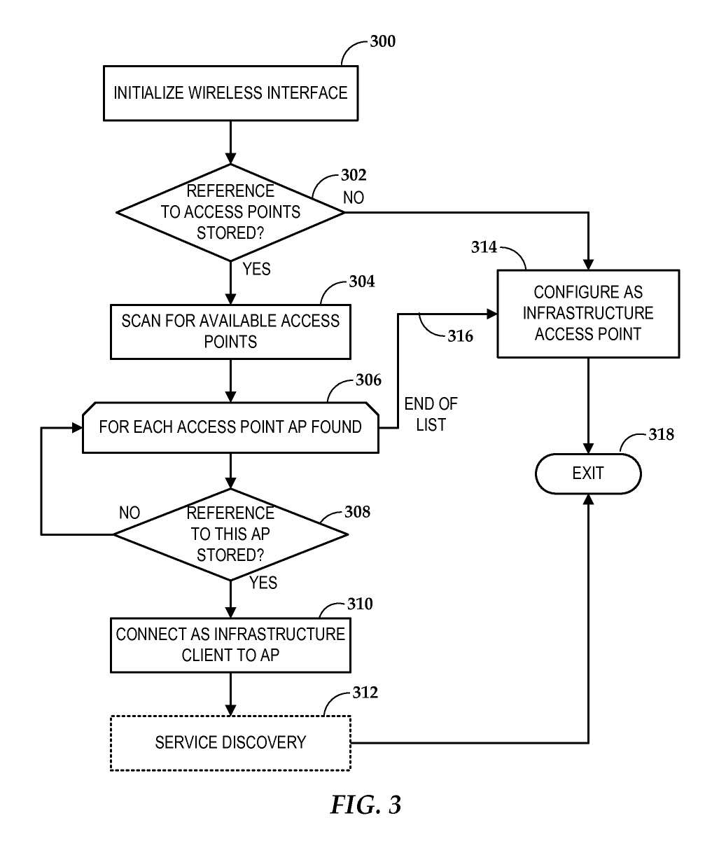

In reference now to FIG. 3, a flowchart illustrates a procedure 300 for selecting access point modes of a peripheral device according to an example embodiment. This procedure 300 may occur in response to an initialization event, such as power on/off, software reset, activation of network hardware, etc. The device first determines 302 whether any references to known/trusted access points are stored. If not, the device configures 314 itself as an infrastructure AP and exits 318. If there are stored access points, then the device scans 304 for any accessible APs.

The scanning 304 returns a list of APs that are iterated through in loop 306. The list may be empty (e.g., no APs detected), in which case, via path 316, the device configures itself 314 as an infrastructure AP and exits 318. For a non-empty list, each AP in the list is checked 308 to see if a reference to the AP is stored with the device. If so, the device connects 310 to the AP as an infrastructure client. This may optionally also involve performing a service discovery operation 312. For example, the operation 312 may involve sending out advertisements on the network that describe the peripheral device and/or its network services so that a user device can connect to it. If none of the detected APs are stored with the device, then the loop 306 exits via path 316, the device configures itself 314 as an infrastructure AP, and exits 318.

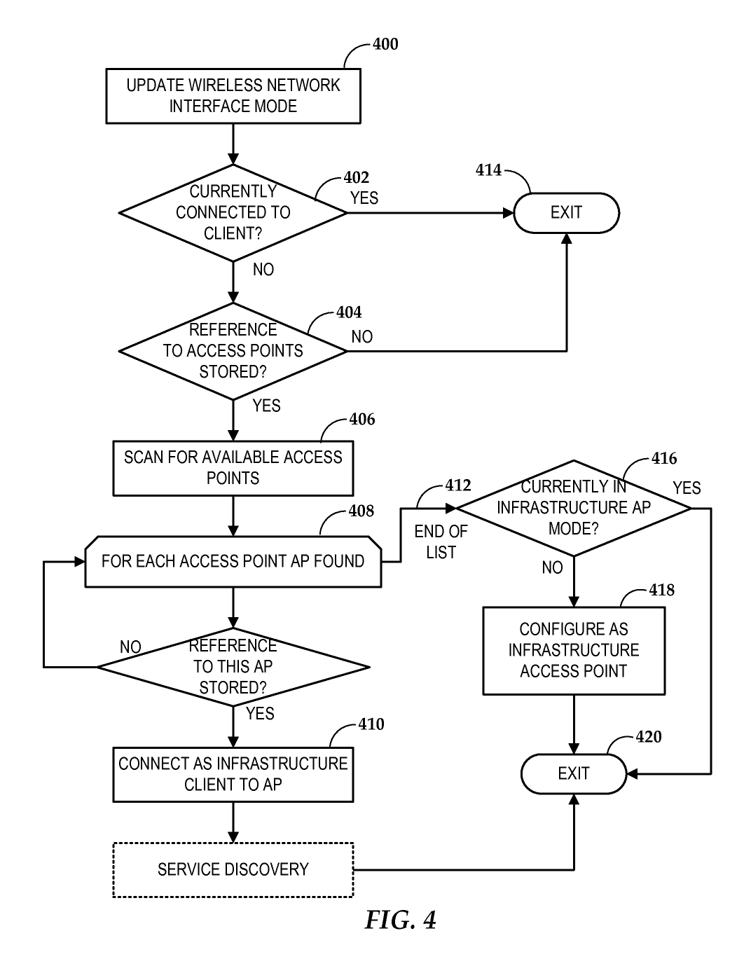

In reference now to FIG. 4, a flowchart illustrates a procedure 400 for updating access point modes of a peripheral device according to an example embodiment. In this case, the wireless network interface may already be operating in infrastructure client or AP mode, but has no active service connections. Otherwise, as indicated by determination 402, the procedure may be configured to exit 414 so as not to disturb an existing session. If it is determined 404 that there are no references to known/trusted APs stored, then the procedure may also exit 414, because in this situation the device may have already had the wireless interface initialized to AP mode, as shown in FIG. 3.

If there are references to one or more trusted APs stored, then the device may proceed to scan 406 for and loop 408 through detected APs, and connect 410 to a trusted AP that is found, similar to the description of similar events in FIG. 3. One difference from FIG. 3 can be seen by check 416, which occurs at the termination 412 of the loop 408. If the check 416 determines that the device is already in AP mode, then the routine can exit 420 without configuring 418 the wireless interface. The determination 416 may return “no” in a situation where the device is in client mode but just lost a connection to the trusted AP (e.g., due to low signal strength), and therefore automatically switches 418 to AP mode.

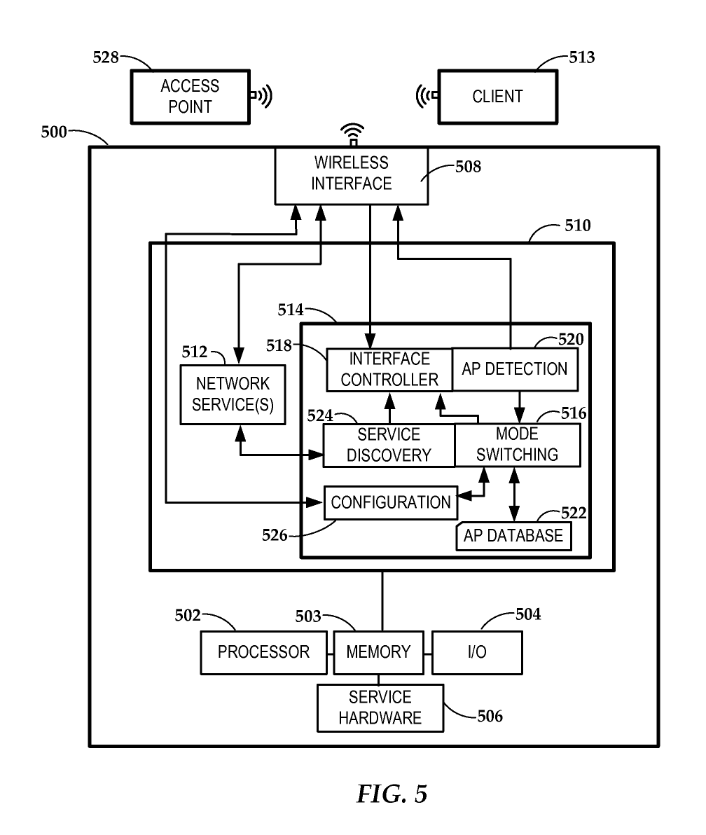

In reference now to FIG. 5, a block diagram illustrates a peripheral apparatus 500 according to an example embodiment. While the apparatus 500 is described as a “peripheral,” it may include hardware commonly associated with any general-purpose or special purpose computing devices, including such hardware as a processor 502, memory 503, and input/output (I/O) circuitry 504. It is to be understood that the apparatus 500 may also include a general-purpose or multi-purpose computing device that, for purposes of the present discussion, is configured to operate as a peripheral, e.g., to provide a network service to a client device via wireless networking, and do so with minimal manual configuration of the apparatus 500.

In addition to the hardware components 502-504, the apparatus 500 may also include service hardware 506 and wireless network interface hardware 508. The service hardware 506 represents any electrical and/or mechanical component that may be associated with a network service provided by the apparatus 500. For example, if the apparatus 500 is configured as a portable data storage device, the service hardware 506 may include a hard disk and/or solid-state memory. Or, if the apparatus 500 is configured as a portable printer, the service hardware 506 may include a print head, paper feed rollers, motors, sensors, etc. The wireless network interface 508 includes circuitry that facilitates wireless communications over the air in conformance with standards such as 802.11 wireless networking.

The apparatus 504 includes data and processor-executable instructions, generally indicated as functional modules 510. The functional modules 510 may include any combination of instructions stored on a non-transitory computer readable medium, firmware, and/or circuitry hardcoded with instructions (e.g., application-specific integrated circuits). The functional modules 510 may be included at the time of manufacture, and/or be added later by the user or any intermediary. For example, software instructions may be provided by way of a non-transitory, computer readable medium (e.g., magnetic or optical storage media, solid state memory), via a network, and/or via other communications using I/O circuits 504.

The functional modules 510 may include, but are not limited to, any combination of programs, libraries, services, operating system components, scripts, configuration files, binary data, drivers, logic circuits, and the like. One functional module 510 is a network service module 512 that provides one or more services to a client 513 via the wireless interface 508. This provision of services may involve accessing to service hardware 506. For example, the network service module 512 may process service requests on behalf of the client device 513 which are applied to service hardware 506. Similarly, the network service module 512 may detect signals and/or data from the hardware 506, and send this as network data to the client device 513 via the wireless interface 508.

A collection of network control modules 514 facilitate access to the network services module 512 by the client 513 under a number of conditions. The modules 514 may apply network change automatically to the apparatus 500, so as to minimize or eliminate the need for direct user interaction with the apparatus 500. For example, a mode switching module 516 may be configured to change an operating mode of the wireless interface 508 by sending commands to an interface controller module 518. The interface controller module 518, along with access point detection module 520, may be provided as drivers and/or system services that facilitate software control of various aspects of the wireless interface hardware 508. The interface controller module 518 may allow other modules 510 to, for example, set parameters for connection to wireless networks, send/receive data via the network, etc. The access point detection module 520 may represent a subset of wireless interface 508 functionality. This subset of functionality may include regular scanning for 802.11 beacon frames, which include SSIDs of nearby APs. The module 520 may update a list of available SSIDs (and other data) based on detection of the beacon frames.

The mode switching module 516 may regularly receive SSID updates from the detection module 520, e.g., caused by wireless APs coming into and out of reception range due to relocation of the apparatus 500. The mode switching module 516 may compare these SSIDs with those stored in a database 522. The mode switching module 516 may automatically switch the network interface 508 from a current mode to a new mode in response to conditions (e.g., existing sessions with client 513, current mode of the wireless interface 508, and data stored in the database 522). The current and new modes may include any combination of infrastructure AP mode, infrastructure client mode, and ad-hoc mode.

In some situations (e.g., switching to a client or ad-hoc mode) the network control modules may send out service discovery data via service discovery module 524. Generally, service discovery module 524 may send out data over the wireless interface that allows the client 513 (or any wireless network node) to identify the apparatus 500 and/or its available services 512. Examples of service discovery protocols include Simple Service Discovery Protocol (SSDP), Service Location Protocol (SLP), Jini, Salutation, etc. Using SSDP as an example, a service provider (e.g., apparatus 500) sends out multicast messages (SSDP:alive) that advertise the device. Another device (e.g., client 513) receives those advertisements. Data in the advertisements allows the other device 513 to engage in additional transactions to discover and utilize the network service 512. This type of SSDP service discovery can be done on a peer-to-peer basis, e.g., without requiring centralized servers to mediate service negotiations. Other service discovery protocols may provide similar features, e.g., advertising of services/devices, negotiation of parameters, and facilitating connections to utilize network services.

As noted above, the access point database 522 includes data that may determine whether or not the mode switching module 516 causes changes to the wireless interface 508. Lack of data in the database 522 (e.g., un-configured state) may also affect operation of the mode switching module 516 (e.g., cause default switching to infrastructure AP mode). This database 522 may be pre-populated with data in some instances, e.g., with a list of SSIDs associated with a trusted provider. In other cases, the database 522 can be populated by the user, such as via a configuration module 526.

The configuration module 526 facilitates user control of various aspects of the mode switching module 516, including the adding and deleting of entries from the access point database 522. The configuration module 526 may allow the user configure the apparatus 500 via the network interface using client device 513. In another case, the configuration module 508 may determine a configuration directly from hardware of the apparatus 500. For example, the wireless interface 508 may include a device (e.g., switch or NFC device) that facilitates user association of the apparatus with an external AP 528 via WPA. In such a case, an identifier of the AP 528 can be automatically added to the database 522 once the association is made.

It will be understood that the depiction of the apparatus 500 is for purposes of illustration, and not limitation. The particular modules shown may be implemented in more or fewer units, for example. Also, the linkages between modules are provided for purposes of illustration, and need not be limited to the interconnections and/or directions of data flow shown. Similarly, the hardware components may be combined into composite units and/or distributed among more units than illustrated.

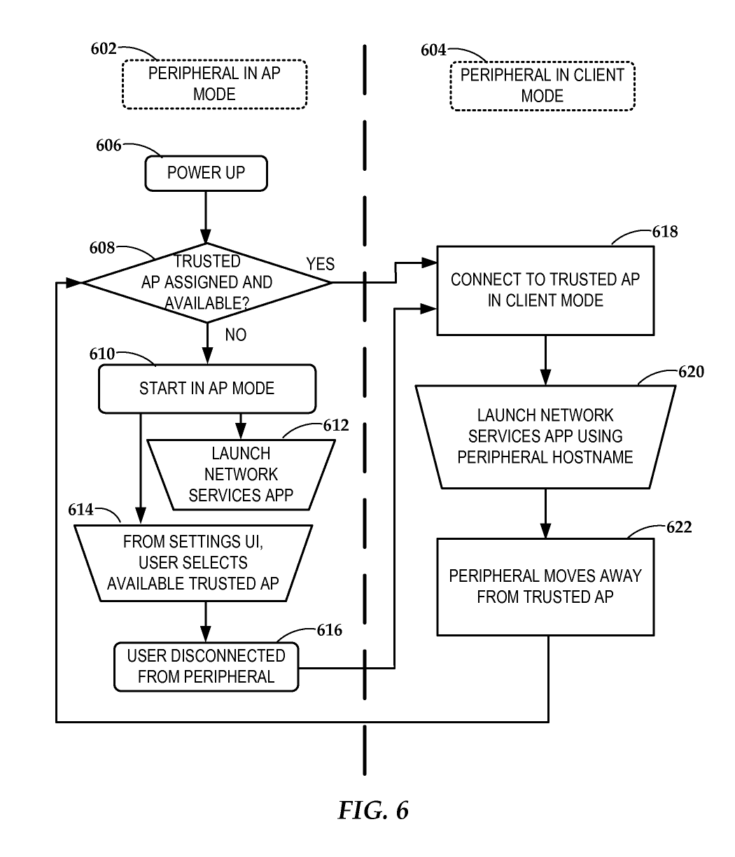

In reference now to FIG. 6, a flowchart illustrates another procedure according to an example embodiment. The flowchart provides an example of a peripheral device transitioning between respective infrastructure AP and infrastructure client modes 602, 604. Upon power up 606, the peripheral device may check 608 to determine if a trusted AP is assigned and available. If neither, then the peripheral may start 610 in AP mode, after which the user may either use 612 the network service (e.g., by launching an application on a user device) or configure 614 a trusted AP from a GUI (e.g., browser).

Use 612 of the network service may be triggered by a user accessing an application the user device, e.g., a requesting to use a service of the peripheral device. This may also involve automatically configuring the user device as an infrastructure mode client to access the peripheral. The peripheral may be operating as an infrastructure AP or as an infrastructure client at the time of the request. If the peripheral's AP is found by the user device, the application may disconnect the user device from a currently connected AP (if applicable) and connect to the peripheral's AP. If the peripheral's AP is not found, the user device application may alternatively perform service discovery on a currently connected network to see if the peripheral is connected instead as an infrastructure client. If the peripheral device is found based on service discovery, the user device can connect as shown in block 618.

If the user configures 614 an available trusted AP, the user device is disconnected 616, and connects 618 to the peripheral in AP mode. This connection 618 may also occur automatically from power up 606 if the trusted AP is assigned and detected 608. After connection 618 in client mode, the network service can be utilized 620, e.g., by using a hostname of the peripheral that may be made available via service discovery and/or local name server. If the peripheral is moved 622 away from the current trusted AP, it may either go back to AP mode 610 or connect 618 with another available trusted peripheral.

The various embodiments described above may be implemented using circuitry and/or software modules that interact to provide particular results. One of skill in the computing arts can readily implement such described functionality, either at a modular level or as a whole, using knowledge generally known in the art. The structures and procedures shown above are only a representative example of embodiments that can be used to facilitate connection of network devices as described above.

The foregoing description of the example embodiments has been presented for the purposes of illustration and description. It is not intended to be exhaustive or to limit the inventive concepts to the precise form disclosed. Many modifications and variations are possible in light of the above teaching. Any or all features of the disclosed embodiments can be applied individually or in any combination are not meant to be limiting, but purely illustrative. It is intended that the scope be limited not with this detailed description, but rather determined by the claims appended hereto.

What is claimed is:

1. An apparatus configured to:
set a wireless network interface of the apparatus to operate in an infrastructure client mode if at least one predetermined wireless access point is detected via the wireless network interface, otherwise configure the wireless network interface to operate in an infrastructure access point mode; and
provide a network service of the apparatus via the configured wireless network interface.

2. The apparatus of claim 1, wherein the apparatus comprises a portable data storage device, and wherein the network service comprises at least one of a file sharing service and a media streaming service.

3. The apparatus of claim 1, wherein a user device automatically connects to the peripheral device in an infrastructure access client point mode when a user device requests the network service.

4. The apparatus of claim 1, wherein, if the wireless network interface is configured to operate in the infrastructure client mode, the processor further causes the apparatus to provide service discovery information usable by a client device to access the network service.

5. The apparatus of claim 1, wherein the wireless network interface comprises a wireless local area network interface, and wherein the infrastructure client and access point modes comprise wireless local area network modes.

6. The apparatus of claim 1, wherein the apparatus is further configured to store a reference to the at least one predetermined wireless network access point.

7. The apparatus of claim 6, wherein, if the reference to the at least one predetermined wireless network access point is not stored with the apparatus, the apparatus configures the wireless network interface to operate in the infrastructure access point mode.

8. The apparatus of claim 6, wherein the apparatus facilitates user definition of the reference and storage thereof with the apparatus via the wireless network interface.

9. The apparatus of claim 1, further comprising a processor and a memory, wherein the memory includes instructions operable by the processor to perform the operations set forth in claim 1.

10. The apparatus of claim 1, wherein the at least one predetermined wireless access point comprises a trusted wireless access point.

11. The apparatus of claim 1, wherein the configuration of the wireless network interface if the at least one predetermined wireless access point is detected or not detected occurs without user interaction with the apparatus to effect the configuration of the wireless network interface.

12. The apparatus of claim 1, further comprising a user device to receive the network service, wherein the user device comprises least one of a tablet computer, a mobile phone, a laptop computer, and a navigation device.

13. A method comprising:
configuring a wireless network interface of an apparatus to operate in an infrastructure client mode if at least one predetermined wireless access point is detected via the wireless network interface, otherwise configuring the wireless network interface to operate in an infrastructure access point mode; and
providing a network service of the apparatus via the configured wireless network interface.

14. The method of claim 13, wherein the network service comprises at least one of a file sharing service and a media streaming service, and wherein the apparatus comprises a portable data storage device.

15. The method of claim 13, further comprising, if the wireless network interface is configured to operate in the infrastructure client mode, providing service discovery information usable by a client device to access the network service.

16. The method of claim 13, wherein the wireless network interface comprises a wireless local area network interface, and wherein the infrastructure client and access point modes comprise wireless local area network modes.

17. The method of claim 13, further comprising storing a reference to the at least one wireless network access point with an apparatus.

18. The method of claim 17, further comprising, if the reference to the at least one predetermined wireless network access point is not stored with the apparatus, configuring the wireless network interface to operate in the infrastructure access point mode.

19. The method of claim 17, further comprising facilitating user definition of the reference and storage thereof with the apparatus via the network interface.

20. The method of claim 13, wherein the configuration of the wireless network interface if the at least one predetermined wireless access point is detected or not detected occurs without user interaction with the apparatus to effect the configuration of the wireless network interface.

21. A computer-readable medium configured with instructions operable by an apparatus to cause the apparatus to perform:
configuring a wireless network interface of the apparatus to operate in an infrastructure client mode if at least one predetermined wireless access point is detected via the wireless network interface, otherwise configuring the wireless network interface to operate in an infrastructure access point mode; and
providing a network service of the apparatus via the configured wireless network interface.

22. The computer-readable medium of claim 21, wherein the configuration of the wireless network interface if the at least one predetermined wireless access point is detected or not detected occurs without user interaction with the apparatus to effect the configuration of the wireless network interface.
